(19) United States
(12) Patent Application Publication
(10) Pub. No.: US 2003/0068145 A1
(43) Pub. Date: Apr. 10, 2003

(54) Central strength member with reduced radial stiffness

(75) Inventors: Nicholas V. Nechitailo, Conover, NC (US); Dean J. Rattazzi, Hickory, NC (US)

Correspondence Address: SUGHRUE, MION, ZINN,, MACPEAK & SEAS, PLLC, 2100 Pennsylvania Avenue, NW, Washington, DC, 20037-3213, US

(73) Assignee: ALCATEL

(21) Appl. No.: 09/972,901

(22) Filed: Oct. 10, 2001

(51) Int. Cl. G02B 6/44

(52) U.S. Cl. 385/103; 385/113

(57) ABSTRACT

An optical fiber cable configuration having a central strength member. The central strength member includes a hollow tube. One or more strength rods are disposed loosely in the hollow tube. To avoid water penetration, the hollow tube is filled with a gel or water-absorbing powder to provide a water barrier.

### BACKGROUND OF THE INVENTION

1. Field of the Invention

The present invention generally relates to the field of fiber optic cables and, in particular, the present invention is directed to a fiber optic cable configuration having a central strength member with reduced radial stiffness.

2. Discussion of Related Art

Optical fibers are very small diameter glass strands that are capable of transmitting an optical signal over great distances, at high speeds, and with extremely low signal loss as compared to standard wire or cable networks. Optical fiber has found increasingly widespread application and currently constitutes the backbone of the worldwide telecommunication network. Because of this development, there has been a growing need for better quality optical fiber cables with a decrease in production time and costs, while ensuring adequate robustness for continued operation in increasingly harsh conditions. Proper signal transmission requires structurally sound jackets and protective covers to protect the optical fiber from potentially damaging external forces.

In general, optical fibers are manufactured from relatively large diameter glass preforms. Fiber optic preforms are generally made with concentric glass layers. The inner layer, or core, is made of a very high quality, high purity SiO₂ glass. This high purity core is the portion of the optical fiber in which the optical data is transmitted. Concentrically positioned around the high purity core is a second layer of glass, or cladding, with a lower index of refraction than the inner core, and generally is less pure. The difference in refraction indices between the core and cladding allows the optical signals in the core to be continuously reflected back into the core as they travel along the fiber. The combination of the core and cladding layers is often referred to as the “primary preform.” The optical fiber is formed by heating and softening a portion of the preform, and rapidly drawing the softened portion with specialized equipment. The length of the drawn optical fiber is typically several thousands of times the length of the primary preform. The aggregate of the optical fiber, jackets and additional integrated mechanical supports is typically referred to as an optical fiber cable. An integral part of the optical fiber cable configuration is a central strength member. The central strength member (CSM) is traditionally used to provide protection to the cable against strains arising from material contraction at low temperatures, as well as under cable bending and tension forces, which are often present during cable installation conditions.

A traditional optical fiber cable configuration 10 is shown in FIG. 1. An outer jacket 12 is provided to enclose and protect a plurality of buffer tubes 14. The buffer tubes may contain loose optical fibers, or optical fiber ribbons 16. The buffer tubes 14 are radially disposed around a central strength member (CSM) 18. The CSM is commonly made of glass reinforced plastic (GRP) and is used to provide strength and support to the cable configuration 10. Each of the buffer tubes 14 may contain loose fibers 16 or fiber ribbons. U.S. Pat. No. 5,621,841 discloses an optical fiber configuration having a CSM. The buffer tubes are stranded or wrapped around the CSM. The buffer tubes are enclosed by an armor layer and an outer sheath.

Recently, cable manufacturers have been attempting to increase the number of fibers per cable, in addition to reducing the amount of materials used, so as to limit the size of the cables. As a result, buffer tubes have been made to have thinner protective walls, which are commonly made of polypropylene and polybutylene terephthalate (PBT). It has recently been observed that cable configurations designed according to traditional standards are prone to suffer severe damage during installation and sheave testing. Specifically, it has been found that when the cable configuration is compressed in transverse or radial directions, for example when bent around a sheave or subjected to an external crushing force, the buffer tubes become permanently flattened or indented. In many cases, the buffer tubes tear open, which allows for fiber bundles to protrude out from the buffer tubes, resulting in significant attenuation problems.

A main cause of the damage to the buffer tubes is due to a force exerted onto the buffer tubes by the CSM. As disclosed in U.S. Pat. No. 5,621,841, the CSM is often made to be incompressible in compression with other elements of the cable. In other words, the radial stiffness of the CSM is much higher than that of the buffer tube. As a result of the CSM being incompressible in comparison with other elements such as the buffer tubes, external compression forces are not absorbed by the CSM, but instead are transmitted from the CSM to the buffer tubes and absorbed by the buffer tubes. As can be seen with reference to FIG. 2, when a compression force F is applied to the cable configuration 10, certain buffer tubes 14 are crushed because the rigid CSM 18 transfers a compression force to the buffer tubes 14, which means that the buffer tubes 14 must absorb the force. Accordingly, the buffer tubes 14 often collapse and recess inwardly causing the optical fibers 16 to exert forces upon the inside of the buffer tubes 14. When either the force of the CSM upon the buffer tubes 14 or the internal force exerted by the optical fibers 16, is large enough, the buffer tubes 14 split open.

Thus, what is needed is a CSM that does not subject the buffer tubes to unacceptable radial forces, when the cable is bent or crushed.

### SUMMARY OF THE INVENTION

The present invention is directed to eliminating the above problems associated with the high fiber count optical cables. Thus, the invention improves the quality of the optical fiber cable and provides for a cable configuration that can withstand forces, such as those induced by installation and sheave loads.

The present invention addresses the above problems by providing a modified strength member for an optical fiber cable. The modification is based on the substitution of the conventional solid rod configuration CSM with a hollow tube configuration CSM. The tube contains one or more GRP or other strength rods, positioned loosely in the tube. To avoid water penetration or a “water hose” effect, the tube is filled with a gel or water-absorbing powder or any other water barrier material known in the art.

The present invention further provides for an optical fiber cable configuration having an outer jacket with at least one buffer tube disposed within the outer jacket. One or more optical fibers are positioned in the buffer tube. The buffer tube is stranded around a central strength member, which is disposed longitudinally along the axis of the outer jacket. The CSM has a hollow portion with at least one strength rod loosely positioned within the hollow portion. A gel or water-absorbing powder may be used as a water barrier in the CSM.

The present invention still further provides for an apparatus for an optical fiber configuration including an outer jacket, at least one buffer tube disposed inside of the outer jacket, at least one optical fiber positioned along the buffer tube, and means for strengthening. The means for strengthening is disposed longitudinally along the cable axis, and is operative to have a degree of deformation when a load is applied to the optical fiber configuration. The buffer tube is also operative to have a degree of deformation when the load is applied to the optical fiber cable. According to the present invention, the means for strengthening has a higher degree or the same degree of deformation as the buffer tube when the optical fiber cable is subjected to radial and transverse loads.

These and other objects and advantages of the present invention will become apparent in the course of the following description.

### BRIEF DESCRIPTION OF THE DRAWINGS

The advantages, nature and various additional features of the invention will appear more fully upon consideration of illustrative embodiments of the invention which are schematically set forth in the drawings, in which:

FIG. 1 is a sectional view of a traditional optical fiber cable configuration;

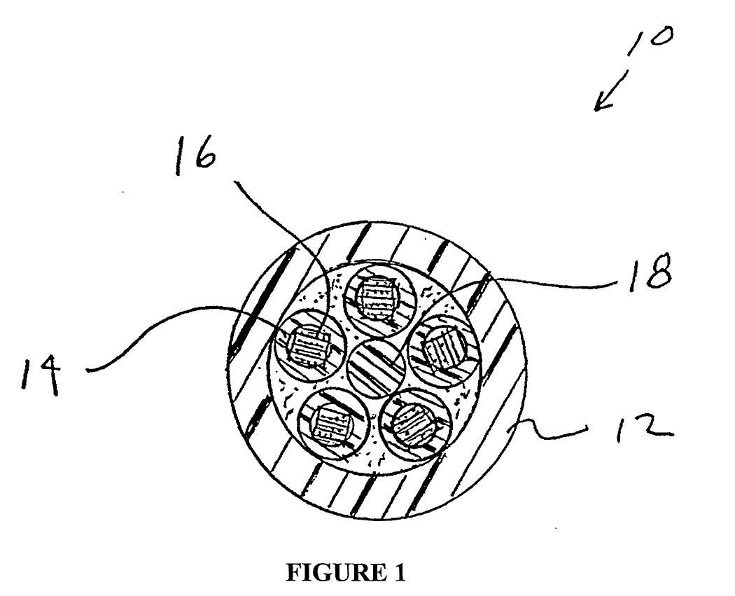

FIG. 2 is a sectional view of the traditional optical fiber cable configuration of FIG. 1 when subjected to a transverse compression force;

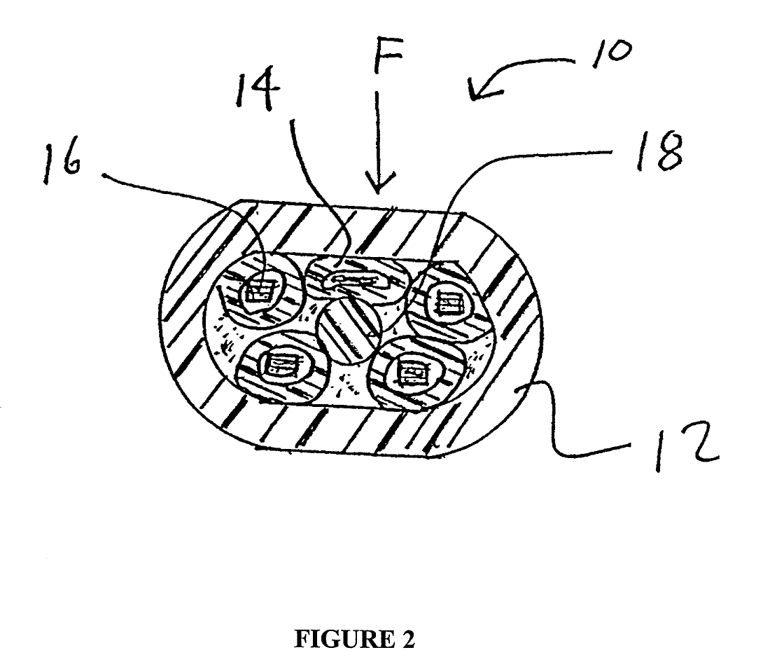

FIG. 3 is sectional view of an optical fiber cable configuration according to the present invention;

FIG. 4 is sectional view of the optical fiber configuration of FIG. 3 according to the present invention when subjected to a compression force;

FIG. 5 is sectional view of another optical fiber configuration according to the present invention; and

FIG. 6 is sectional view of the optical fiber configuration of FIG. 5 when subjected to a compression force.

### DETAILED DESCRIPTION OF THE PREFERRED EMBODIMENTS

The present invention will be explained in further detail by making reference to the accompanying drawings, which do not limit the scope of the invention in any way.

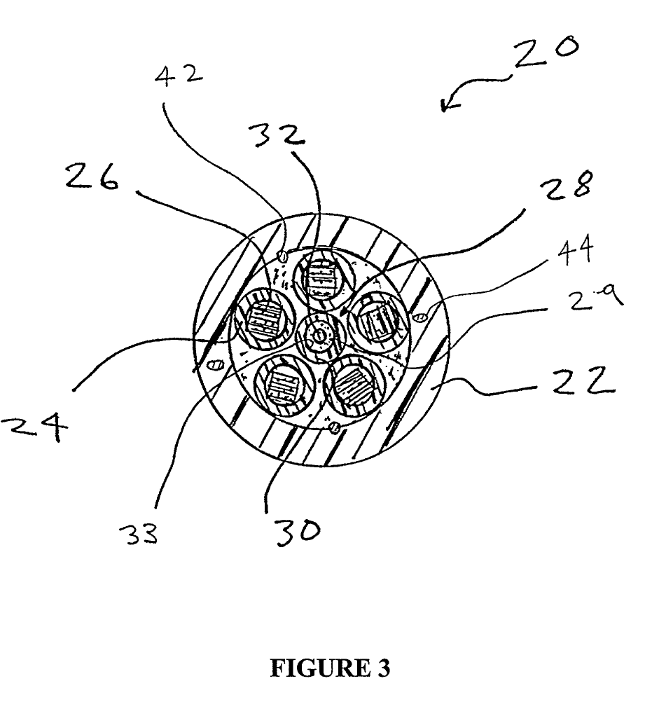

With reference to FIG. 3, an optical fiber cable configuration 20 is shown having a tubular outer jacket 22. The outer jacket 22 is used to house a plurality of buffer tubes 24. The buffer tubes 24 contain optical fiber ribbons 26. As one skilled in the art will appreciate, the buffer tubes 24 may also contain other formations of optical fibers. In this embodiment, five buffer tubes are shown; however, the number of buffer tubes 24 may be increased or decreased depending on the application.

According to the present invention, a CSM 28 is positioned concentrically with respect to the outer jacket 22. The CSM 28 includes a tube or strength tube 30, which has a hollowed-out center portion. The tube 30 may be made from a plastic, for example, polyethylene, polypropylene, PBT, PVC and plastic-based composite materials. A large variety of materials including metal, non-metal and composite materials may be used; however, tubes made of a material having a high-Young's modulus should have thinner walls as compared to those made of a softer material, in order to provide for a radial or bending stiffness and flexibility close to that of surrounding buffer tubes. According to the invention, it is desired to have a tube 30 with a bending stiffness close to that of the buffer tubes 24. The bending stiffness of a traditional CSM is typically much greater than the bending stiffness of surrounding buffer tubes. The equation for the bending stiffness is:

$$D = \frac{E {h}^{3}}{12 ( 1 - {v}^{2} )} ,$$

where E is the Young's modulus, ν is the Poisson's ratio and h is the wall thickness.

As can be seen from the equation, a small increase in the wall thickness (h) results in a significant increase in the stiffness of the tube.

An inner strength member or strength rod 32 is disposed longitudinally within the hollow portion of the tube 30, and may comprise a high-strength, high-Young's modulus material such as a glass-reinforced plastic. Also, a varying number of strength rods 32 may be used in the tube 30 depending on the application. To avoid water penetration or a “water hose” effect, the tube is filled with a gel or water-absorbing powder 29 or any other water barrier material known in the art.

An inner diameter of the hollow tube 30 is dimensioned to be larger that an outside diameter of the strength rod 32, such that an open space exists between at least a portion of the strength rod 32 and an inner wall 33 of the tube 30. Because of the space between the strength rod 32 and the tube 30, the strength rod 32 is permitted to move around in the hollow portion of the tube 30. Other high-strength, high-Young's modulus materials, such as steel wire and other metal alloys, and metal and non-metal composites with a low coefficient of thermal expansion, can be used as the strength rod 32. The use of a material having a low coefficient of thermal expansion is preferred due to its resistance to thermal contraction at low temperatures.

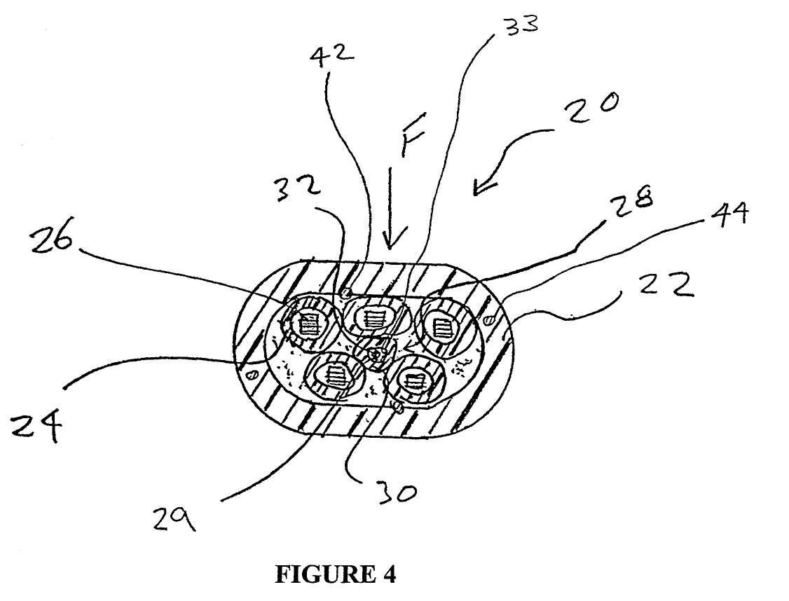

FIG. 4 shows the optical fiber configuration 20 being acted on by an external compression force, such as that caused by sheave loading. The force F compacts the buffer tubes 24 against one another and against the CSM 28. However, according to the present invention, the tube 30 of the CSM 28, in addition to the buffer tubes 24, are operative to be deformed. As a result, the tube 30 absorbs a portion of the force F as opposed to transferring substantially all of the force back upon the buffer tubes 24. The tube 30 is capable of absorbing a portion of the force F because it is designed to have a stiffness in the radial direction that is below or close to that of the buffer tube 24. Because the strength rod 32 is movably positioned within the tube 30, it is able to change its position in accordance with the changing shape of the tube 30.

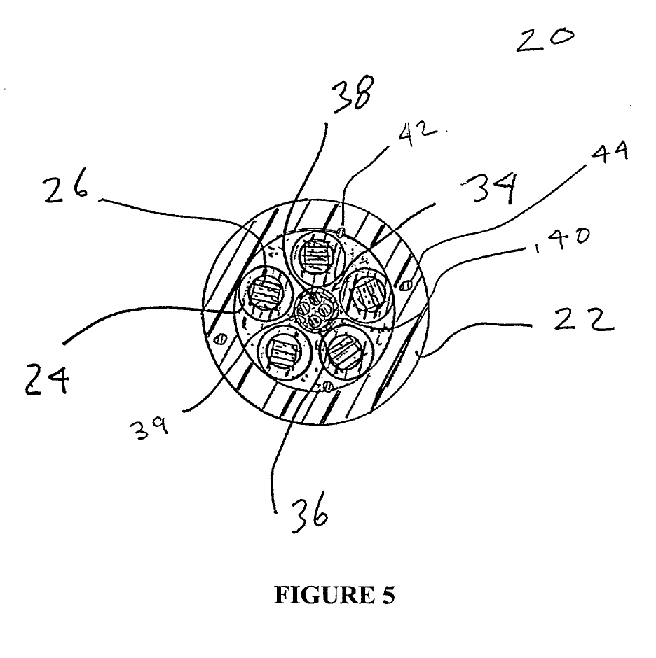

With reference to FIG. 5, another exemplary embodiment of an optical fiber cable configuration 20 according to the present invention is illustrated. Similar to the embodiment of FIG. 3, a tubular outer jacket 22 is used to house a plurality of buffer tubes 24, which are disposed in a radial arrangement, and contain an arrangement of optical fibers, such as in the form of ribbons 26.

In further accordance with the embodiment shown in FIG. 5, a CSM 34 is positioned centrally with respect to the outer jacket 22. The CSM 34 includes a tube or strength tube 36 that has a hollowed-out center portion. The tube 36 may be made of a plastic, such as that described above in reference to the embodiment of FIG. 3, and may have similar material properties. A plurality of inner strength members or strength rods 38 are disposed within the hollow portion of the tube 36, and may be loosely positioned along an inner wall 39 of the tube 36. The strength rods 38 may respectively be made of a material, such as a glass reinforced plastic, as described above in reference to the embodiment of FIG. 3.

A diameter of the hollow center of the tube 36 is dimensioned to allow for the strength rods 38 to be movable within the hollow portion of the tube 36. Thus, the strength rods 38 are permitted to change their location within the tube 36. This aspect allows for the strength rods 38 to conform to a change in shape by the tube 36, while still providing rigidity and support for the overall cable configuration 20. To avoid water penetration or a “water hose” effect, the tube is filled with a gel or water-absorbing powder 40 or any other water barrier material known in the art.

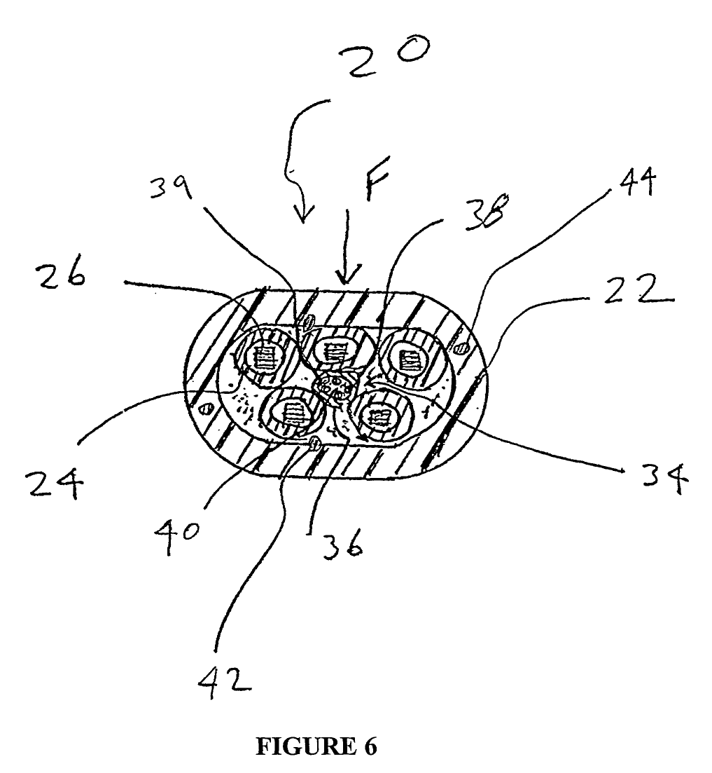

FIG. 6 shows the optical fiber configuration 20 of FIG. 5 being acted on by an external compression force F, such as that caused by a sheave load. A sheave load is caused by the cable 20 being dragged over a sheave. Depending on the number of movable strength rods 38 and their deformation mode, the strength rods 38 will provide support for the CSM 34 during deflection caused by the load. For example, three parallel rods positioned approximately 120° with respect to each other will not engage with each other, thus allowing for a larger deformation of the tube 36 without increased resistance. The load between the sheave and strength rods 38 is a function of speed, wherein the movability of the strength rods 38 allows for the load to be distributed in accordance with the load. After the load is removed, the strength rods 38 are operable to return back to their initial position.

As in the embodiment of FIGS. 3 and 4, the force F compacts the buffer tubes 24 against one another and against the CSM 34. According to this embodiment, the tube 36 of the CSM 34 is operative to be deformed by the forces that are transferred from the buffer tubes 24. As a result, the tube 36 absorbs a portion of the force as opposed to transferring it all back upon the buffer tubes 24. The tube 36 is capable of absorbing a portion of the force F because it is designed to have a stiffness in the radial direction, which is close to or smaller than that of the buffer tubes 24.

When comparing the multiple strength rod configurations of FIGS. 5 and 6 and the single strength rod configurations of FIGS. 3 and 4, it is preferable that the cross-sectional area of the single strength rod 32 of FIGS. 3 and 4 be equal to the sum of the cross-sectional areas of the plurality of strength rods 38 of FIGS. 5 and 6, if they are made of the same material. Of course other relative dimensions are considered to be within the scope of the invention.

Although the invention is described as using a central strength member, it will be appreciated that other strength members may be used, in addition to the central strength member. For example, as shown in FIGS. 3-6, strength yarn 42 and radial strength members 44 may be positioned in or under the outer jacket in a traditional way. The additional load-carrying strength yarns and radial strength members may be added if there is a need to increase the stiffness of the load-carrying elements.

It is, of course, understood that departures can be made from the preferred embodiments of the invention by those of ordinary skill in the art without departing from the spirit and scope of the invention that is limited only by the following claims.

What is claimed:

1. A strength member for an optical fiber cable, said strength member comprising:
a tube having a hollow portion, said tube being positioned adjacent to at least one element housing an optical fiber.

2. A strength member for an optical fiber cable, said strength member comprising:
a tube having a hollow portion, said hollow portion having an inner wall; and
a strength rod positioned within said hollow portion, wherein an open space is provided between at least a portion of said strength rod and said inner wall of said hollow portion.

3. The strength member of claim 2, further comprising a water barrier material disposed within said hollow portion of said tube.

4. The strength member of claim 2, wherein a plurality of strength rods are provided along said hollow portion.

5. The strength member of claim 4, further comprising a water barrier material disposed within said hollow portion of said tube.

6. The strength member of claim 4, wherein said plurality of strength rods are movably positioned within said hollow portion.

7. The strength member of claim 4, wherein said plurality of strength rods are loosely disposed on said inner wall.

8. The strength member of claim 2, wherein said tube comprises plastic.

9. The strength member of claim 2, wherein said strength rod comprises glass-reinforced plastic.

10. An optical fiber cable configuration comprising:
an outer jacket;
at least one buffer tube disposed within said outer jacket;
at least one optical fiber positioned longitudinally within said buffer tube;
a strength member disposed longitudinally along a center portion of said outer jacket, said strength member including,
a strength tube having a hollow portion extending longitudinally along said strength tube, said hollow portion having an inner wall; and
a strength rod positioned along said hollow portion, wherein an open space is provided between at least a portion of said strength rod and said inner wall of said hollow portion.

11. The optical fiber cable configuration of claim 10, further comprising a water barrier material disposed within said hollow portion of said strength tube.

12. The optical fiber cable configuration of claim 10, wherein said strength member has a stiffness in a radial direction that is less than a stiffness in a radial direction of said buffer tube.

13. The optical fiber cable configuration of claim 10, wherein a plurality of buffer tubes are positioned radially around said strength member.

14. The optical fiber cable configuration of claim 10, further including at least one strength yarn.

15. The optical fiber cable configuration of claim 10, further including at least one radial strength member in said jacket.

16. The optical fiber cable configuration of claim 10, wherein a plurality of strength rods are provided along said hollow portion.

17. The optical fiber cable configuration of claim 16, further comprising a water barrier material disposed within said hollow portion of said strength tube.

18. The optical fiber cable configuration of claim 16, wherein said plurality of strength rods are movably positioned within said hollow portion.

19. The optical fiber cable configuration of claim 16, wherein said plurality of strength rods are loosely disposed on said inner wall of said strength tube.

20. The optical fiber cable configuration of claim 10, wherein said strength tube comprises plastic.

21. The optical fiber cable configuration of claim 10, wherein said strength rod comprises glass-reinforced plastic.

22. An optical fiber cable configuration comprising:
an outer jacket;
at least one buffer tube disposed within said outer jacket;
at least one optical fiber positioned longitudinally within said buffer tube; and
means for strengthening disposed longitudinally along a center portion of said outer jacket, wherein said means for strengthening is operative to have a degree of deformation when a load is applied to said optical fiber cable configuration, and said buffer tube is operative to have a degree of deformation when the load is applied to said optical fiber cable configuration, such that the means for strengthening has a higher degree of deformation than said buffer tube when said optical fiber cable configuration is subjected to the load.

23. The optical fiber cable configuration of claim 22, wherein the means for strengthening further comprises a water barrier material.

24. The optical fiber cable configuration of claim 22, wherein the load is a radial load.
